(19) United States
(12) Patent Application Publication
(10) Pub. No.: US 2012/0247387 A1
(43) Pub. Date: Oct. 4, 2012

(54) COATING APPARATUS

(75) Inventor: Tatsuya Soma, Kanagawa (JP)

(73) Assignee: SONY CORPORATION, Tokyo (JP)

(21) Appl. No.: 13/416,898

(22) Filed: Mar. 9, 2012

(30) Foreign Application Priority Data
Mar. 30, 2011 (JP) 2011-075292

(51) Int. Cl. B05C 9/02

(52) U.S. Cl. 118/429

(57) ABSTRACT

A coating apparatus includes a liquid storing vessel in which coating liquid to be applied to a coating object is stored, and a film forming body that has an annular shape and includes an opening over which a film is stretched by immersing the film forming body in the coating liquid that is stored in the liquid storing vessel. In the coating apparatus, the film forming body is moved relatively to the coating object and the coating object is inserted into the opening over which the film is stretched, so as to apply the coating liquid on a surface of the coating object.

### CROSS REFERENCES TO RELATED APPLICATIONS

The present application claims priority to Japanese Priority Patent Application JP 2011-075292 filed in the Japan Patent Office on Mar. 30, 2011, the entire content of which is hereby incorporated by reference.

### BACKGROUND

The present application relates to a technical field of a coating apparatus. In particular, the present application relates to a technical field in which coating liquid is applied to a surface of a coating object by a film forming body having an opening over which coating liquid film is stretched, so as to reduce a used amount of the coating liquid.

There is a coating apparatus that applies coating liquid to a surface of a coating object such as a cylindrical base material and a plate-like substrate so as to form a coating film (thin film). As such coating apparatus, there is an apparatus that applies coating liquid to a coating object by employing an immersion method.

In a coating apparatus employing the immersion method, the whole of a coating object is immersed in coating liquid which is stored in an immersion vessel and the coating object is pulled out relatively to the immersion vessel so as to form a coating film on a surface of the coating object.

In such coating apparatus employing the immersion method, the whole of a coating object is immersed in coating liquid, so that a quantity of coating liquid is used. Further, the immersion vessel has to be equal to or larger than the coating object in height, resulting in an increase of the size of the apparatus.

Therefore, such coating apparatus is disclosed that includes an immersion vessel which has a through hole, into which a coating object is inserted, on the bottom thereof and stores coating liquid thereinside, a sealing material for preventing a leak of the coating liquid from a gap between the coating object and the immersion vessel, and the like (for example, Japanese Unexamined Patent Application Publication No. 61-20044 and Japanese Unexamined Patent Application Publication No. 2009-18268).

In such coating apparatus, a coating object is inserted in a through hole formed on an immersion vessel and the coating object is pulled out or the immersion vessel is pulled down in a state that a sealing material contacts with an outer circumferential face of the coating object. When the coating object or the immersion vessel is moved, the coating liquid is sequentially applied from the upper side to the lower side of the outer circumferential face of the coating object and thus a coating film is formed, shaping a photoreceptor or the like.

### SUMMARY

However, in the coating apparatuses disclosed in Japanese Unexamined Patent Application Publication No. 61-20044 and Japanese Unexamined Patent Application Publication No. 2009-18268, the immersion vessel is moved relative to the coating object so as to sequentially apply the coating liquid which is stored in the immersion vessel to the outer circumferential face of the coating object, so that sufficient quantity of coating liquid to be applied to the whole of the outer circumferential face of the coating object has to be stored or supplied from a supply unit. Therefore, the used amount of the coating liquid is large and shaping cost is high disadvantageously. Especially, when the coating liquid is expensive, the shaping cost soars.

Further, in the coating apparatuses disclosed in Japanese Unexamined Patent Application Publication No. 61-20044 and Japanese Unexamined Patent Application Publication No. 2009-18268, the coating object is inserted into the through hole which is formed on the bottom part of the immersion vessel and the coating object is relatively pulled out, so that the configuration for preventing a leak of the coating liquid from the gap between the coating object and the immersion vessel has to be provided, making the configuration of the immersion vessel and the like complicated.

It is desirable to reduce a used amount of coating liquid and simplify the configuration in a coating apparatus according to embodiments of the present application.

A coating apparatus includes a liquid storing vessel in which coating liquid to be applied to a coating object is stored, and a film forming body that has an annular shape and includes an opening over which a film is stretched by immersing the film forming body in the coating liquid that is stored in the liquid storing vessel. In the coating apparatus, the film forming body is moved relatively to the coating object and the coating object is inserted into the opening over which the film is stretched, so as to apply the coating liquid on a surface of the coating object.

Accordingly, in the coating apparatus, the film forming body which is formed in the annular shape and includes the opening is moved relatively to the coating object and the coating object is inserted into the opening over which the film of the coating liquid is stretched, so as to apply the coating liquid on the surface of the coating object.

In the coating apparatus described above, it is preferable that the film forming body include an outer annular portion that is formed in an annular shape and an inner annular portion that is formed in an annular shape, includes the opening, and is protruded from an inner circumferential edge of the outer annular portion, and a front end edge of the inner annular portion be positioned lower than the inner circumferential edge of the outer annular portion.

Thus, the front end edge of the inner annular portion which includes the opening and is protruded from the inner circumferential portion of the outer annular portion which is formed in the annular shape is positioned lower than the inner circumferential edge of the outer annular portion, so that the inner annular portion is more easily immersed in the coating liquid than the outer annular portion.

In the coating apparatus described above, it is preferable that the inner annular portion be tilted with respect to the outer annular portion as being closer to the opening from the inner circumferential edge of the outer annular portion, and an inner circumferential edge of the inner annular portion be positioned inside the inner circumferential edge of the outer annular portion.

Thus, the inner annular portion is tilted with respect to the outer annular portion as being closer to the opening from the inner circumferential edge of the outer annular portion, and an inner circumferential edge of the inner annular portion is positioned inside the inner circumferential edge of the outer annular portion. Accordingly, a gap between the inner circumferential edge of the outer annular portion and the coating object is larger than a gap between the inner circumferential edge of the inner annular portion and the coating object.

In the coating apparatus described above, it is preferable that movement of the film forming body be started in a state that a lower end portion of the coating object and at least the opening of the film forming body are immersed in the coating liquid that is stored in the liquid storing vessel.

Thus, the movement of the film forming body is started in a state that the lower end portion of the coating object and at least the opening of the film forming body are immersed in the coating liquid that is stored in the liquid storing vessel. Accordingly, a film is formed between an outer circumferential face of the coating object and an inner circumferential edge of the film forming body.

In the coating apparatus described above, it is preferable that a dripping prevention body that is formed to have a shape tapered in a direction in which the film forming body is moved be attached on an end portion, which is positioned in the direction in which the film forming body is moved, of the coating object.

Thus, the dripping prevention body that is formed to have a shape tapered in a direction in which the film forming body is moved is attached on the end portion, which is positioned in the direction in which the film forming body is moved, of the coating object, so that dripping of the coating liquid occurs on a surface of the dripping prevention body in a case where the film tears.

In the coating apparatus described above, it is preferable that the film forming body be moved back and forth with respect to the coating object.

Thus, the film forming body is moved back and forth with respect to the coating object, so that the coating liquid is repeatedly applied to the coating object.

It is preferable that the coating apparatus described above further include a liquid supply mechanism configured to supply the coating liquid to a liquid storing portion, and in the coating apparatus, the film forming body include the liquid storing portion that stores the coating liquid and a delivery portion that delivers the coating liquid that is stored in the liquid storing portion to the opening.

Thus, the liquid supply mechanism configured to supply the coating liquid to the liquid storing portion is provided, and the film forming body includes the liquid storing portion that stores the coating liquid and a delivery portion that delivers the coating liquid that is stored in the liquid storing portion to the opening. Accordingly, the coating liquid is supplied to the film which is stretched over the opening of the film forming body.

In the coating apparatus described above, it is preferable that the delivery portion be tilted so as to be displaced downward as being closer to the opening.

Thus, the delivery portion is tilted so as to be displaced downward as being closer to the opening, so that the coating liquid is delivered from the delivery portion to the opening by gravity.

In the coating apparatus described above, it is preferable that the coating liquid that is stored in the liquid storing portion be delivered from the delivery portion to the opening by capillary action.

Thus, the coating liquid that is stored in the liquid storing portion is delivered from the delivery portion to the opening by capillary action, so that a special supply mechanism by which the coating liquid is delivered from the delivery portion to the opening does not have to be used.

A coating apparatus according to an embodiment of the present application includes a liquid storing vessel in which coating liquid to be applied to a coating object is stored, and a film forming body that has an annular shape and includes an opening over which a film is stretched by immersing the film forming body in the coating liquid that is stored in the liquid storing vessel. In the coating apparatus, the film forming body is moved relatively to the coating object and the coating object is inserted into the opening over which the film is stretched, so as to apply the coating liquid on a surface of the coating object.

Thus, the coating liquid is applied on the surface of the coating object by the film which is stretched on the opening of the film forming body, being able to reduce the used amount of the coating liquid.

Further, the coating liquid does not leak from the film forming body, so that a mechanism for preventing dripping does not have to be provided, being able to simplify the configuration of the apparatus.

In another embodiment of the present application, the film forming body includes an outer annular portion that is formed in an annular shape and an inner annular portion that is formed in an annular shape, includes the opening, and is protruded from an inner circumferential edge of the outer annular portion, and a front end edge of the inner annular portion is positioned lower than the inner circumferential edge of the outer annular portion.

Accordingly, even in a case where the film forming body is tilted with respect to the horizontal direction, the inner circumferential edge of the outer annular portion is hardly immersed in the coating liquid and the film can be securely stretched over the opening of the film forming body.

In still another embodiment of the present application, the inner annular portion is tilted with respect to the outer annular portion as being closer to the opening from the inner circumferential edge of the outer annular portion, and an inner circumferential edge of the inner annular portion is positioned inside the inner circumferential edge of the outer annular portion.

Accordingly, the gap between the inner circumferential edge of the outer annular portion and the coating object is larger than the gap between the inner circumferential edge of the inner annular portion and the coating object, being able to prevent part other than the inner circumferential edge of the inner annular portion and the inner circumferential edge of the outer annular portion from contacting with the coating object when the film forming body is moved upward.

In yet another embodiment of the present application, movement of the film forming body is started in a state that a lower end portion of the coating object and at least the opening of the film forming body are immersed in the coating liquid that is stored in the liquid storing vessel.

Accordingly, a film is formed between the outer circumferential face of the coating object and the inner circumferential edge of the film forming body, so that an area of the film is small, being able to reduce the used amount of the coating liquid.

In yet another embodiment of the present application, a dripping prevention body that is formed to have a shape tapered in a direction in which the film forming body is moved is attached on an end portion, which is positioned in the direction in which the film forming body is moved, of the coating object.

Accordingly, dripping of the coating liquid occurs on the surface of the dripping prevention body when the film tears, so that dripping of the coating liquid with respect to the outer circumferential face of the coating object can be prevented, being able to secure a favorable forming state of a coating film with respect to the coating object.

In yet another embodiment of the present application, the film forming body is moved back and forth with respect to the coating object.

Accordingly, the coating liquid can be repeatedly applied to the coating object, being able to adjust the film thickness of the coating film which is formed on the outer circumferential face of the coating object.

In yet another embodiment of the present application, the coating apparatus further includes a liquid supply mechanism configured to supply the coating liquid to a liquid storing portion, and in the coating apparatus, the film forming body includes the liquid storing portion that stores the coating liquid and a delivery portion that delivers the coating liquid that is stored in the liquid storing portion to the opening.

Accordingly, the coating liquid is supplied from the liquid supply mechanism via the liquid storing portion and the delivery portion to the opening, so that the film which is stretched over the opening of the film forming body can be prevented from tearing due to liquid discontinuity and the coating liquid can be applied with respect to a long coating object.

In yet another embodiment of the present application, the delivery portion is tilted so as to be displaced downward as being closer to the opening.

Accordingly, the coating liquid is easily allowed to flow toward the opening by gravity, being able to easily supply the coating liquid to the film which is stretched over the opening.

In yet another embodiment of the present application, the coating liquid that is stored in the liquid storing portion is delivered from the delivery portion to the opening by capillary action.

Accordingly, a special supply mechanism for delivering the coating liquid from the delivery portion to the opening does not have to be provided, being able to simplify the configuration.

Additional features and advantages are described herein, and will be apparent from the following Detailed Description and the figures.

### BRIEF DESCRIPTION OF THE FIGURES

FIG. 1 is a schematic lateral view illustrating a part of a coating apparatus according to an embodiment of the present application as a section together with FIGS. 2 to 19;

FIG. 2 is a schematic sectional view of a film forming body;

FIG. 3 is a schematic plan view of the film forming body;

FIG. 4 is a schematic lateral view illustrating a part of an initial state before a coating liquid is applied to a cylindrical or columnar coating object as a section in an operation of the coating apparatus when the coating liquid is applied to the coating object, together with FIGS. 5 to 13;

FIG. 5 is a schematic lateral view illustrating a part of a state that the coating object is held above the coating liquid, as a section;

FIG. 6 is a schematic lateral view illustrating a part of a state that movement of the film forming body is started and the film forming body is positioned above a liquid face of the coating liquid, as a section;

FIG. 7 is a schematic bottom view illustrating a state that a film of the coating liquid is stretched over an opening of the film forming body;

FIG. 8 is a schematic lateral view illustrating a part of a state that the film forming body is moved higher than a lower surface of the coating object, as a section;

FIG. 9 is a schematic bottom view illustrating a state that part of the film of the coating liquid is stuck to the lower surface of the coating object and a coating film is formed;

FIG. 10 is a schematic lateral view illustrating a part of a state that the film forming body is moved upward at low speed, as a section;

FIG. 11 is a schematic lateral view illustrating a part of a state that first application of the coating liquid with respect to the coating object is completed, as a section;

FIG. 12 is a schematic lateral view illustrating a part of a state that dripping occurs on a dripping prevention body, as a section;

FIG. 13 is a schematic lateral view illustrating a part of a state that the film forming body is moved downward to return to an initial state, as a section;

FIG. 14 is a schematic lateral view illustrating a part of a state before the coating liquid is applied to a spherical coating object, as a section, in an operation of the coating apparatus when the coating liquid is applied to the spherical coating object, together with FIGS. 15 to 17;

FIG. 15 is a schematic lateral view illustrating a part of a state that the movement of the film forming body is started, as a section;

FIG. 16 is a schematic lateral view illustrating a part of a state that the film forming body is moved upward, as a section;

FIG. 17 is a schematic lateral view illustrating a part of a state that application of the coating liquid to the coating object is completed, as a section;

FIG. 18 is a schematic perspective view illustrating a state that the coating liquid is applied to a plate-shaped coating object; and

FIG. 19 is a schematic lateral view illustrating a part of a coating apparatus according to a modification, as a section.

### DETAILED DESCRIPTION

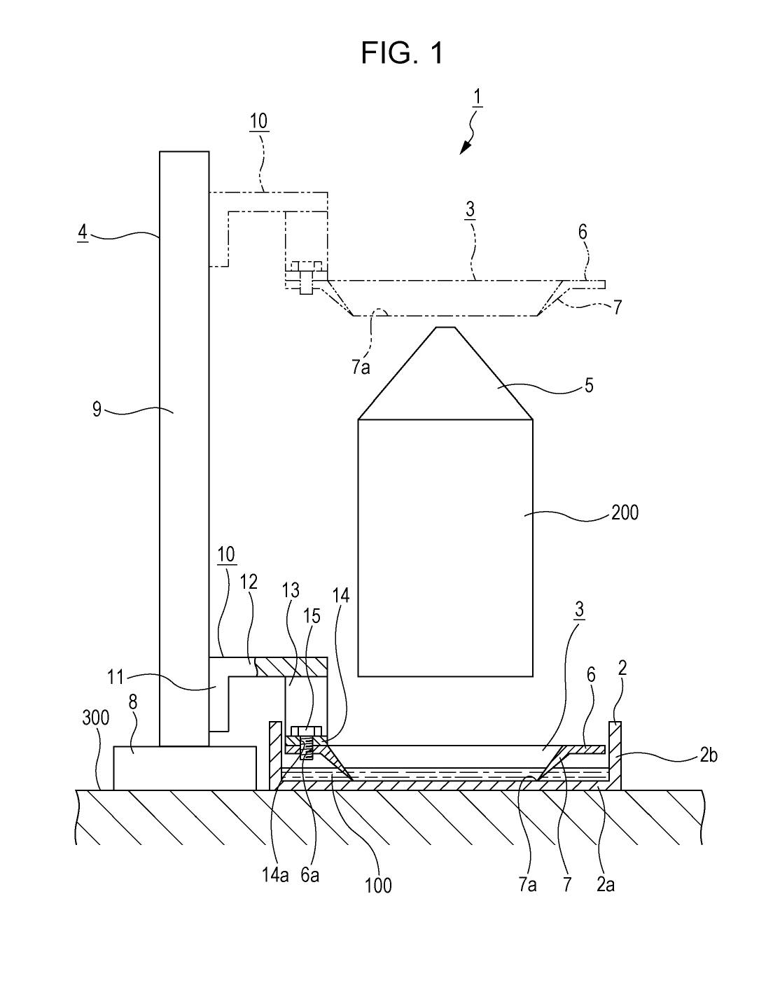

The present application according to an embodiment is described below with reference to the accompanying drawings (refer to FIGS. 1 to 19).

In a preferred embodiment described below, the coating apparatus of the embodiment of the present application is applied to a coating apparatus which performs coating on a coating object which is a cylindrical or columnar base material.

It should be noted that the scope of application of the coating apparatus of the embodiment of the present application is not limited to a coating apparatus which performs coating to a coating object which is a cylindrical or columnar base material. The coating apparatus of the embodiment of the present application may be applied to various coating apparatuses which perform coating with respect to a coating object which is formed to have various shapes such as a spherical shape or a plate-like shape.

In the following description, directions are expressed such that a coating object is disposed so that an axis direction thereof is in a vertical direction and an elevating unit is disposed on the left side of the coating object, as an example. However, the directions described below are used for the sake of convenience of the description, and an operation of the embodiment of the present application is not limited to these directions.

### [Configuration of Coating Apparatus]

A coating apparatus 1 includes a liquid storing vessel 2 in which coating liquid 100 is stored, a film forming body 3 which is moved in the vertical direction, and an elevating unit 4 which moves the film forming body 3 in the vertical direction, as depicted in FIG. 1.

The liquid storing vessel 2 includes a bottom face portion 2a and a circumferential face portion 2b which is protruded upward from an outer circumferential portion of the bottom face portion 2a.

In the liquid storing vessel 2, the coating liquid 100 is stored. As the coating liquid 100, a photosensitive material such as photo-resist, a coating material, or the like is used, for example, and these materials have small surface tension and a certain level of viscosity.

Above the liquid storing vessel 2, a coating object 200 is disposed. The coating object 200 is a cylindrical or columnar base material for forming a photoreceptor drum of an electrophotographic system, for example. The coating object 200 is held by a holding mechanism, which is not depicted, for example, in such direction that the axis direction thereof is in the vertical direction.

On an upper surface of the coating object 200, a dripping prevention body 5 which is formed to have an upward tapered shape is attached. The dripping prevention body 5 has a function to prevent dripping of the coating liquid 100 with respect to the coating object 200 when application of the coating liquid 100 with respect to the coating object 200 is completed, as described later.

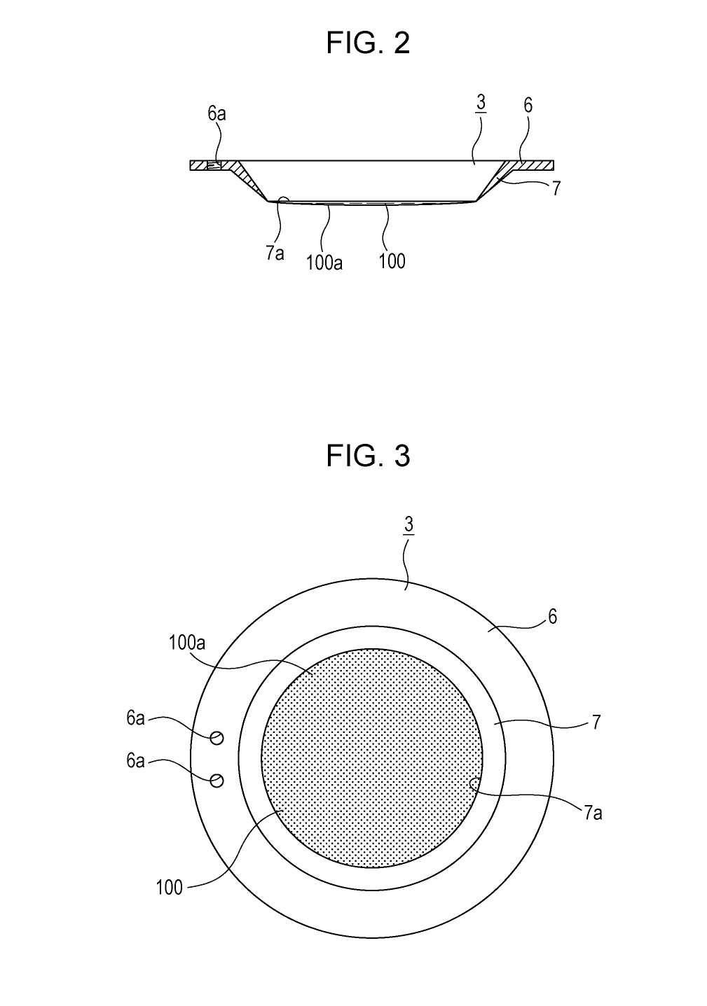

The film forming body 3 is composed of an outer annular portion 6 which is formed to have a plate-like annular shape facing in the vertical direction and an inner annular portion 7 which is protruded from the whole circumference of an inner circumferential edge of the outer annular portion 6 (refer to FIGS. 2 and 3).

On the outer annular portion 6, fixation screw holes 6a and 6a which are threaded are formed.

The inner annular portion 7 is formed in an annular shape and is tilted such that the inner annular portion 7 is displaced inward toward a lower side from the inner circumferential edge of the outer annular portion 6. Accordingly, the inner circumferential edge (front end edge) of the inner annular portion 7 is positioned lower than the inner circumferential edge of the outer annular portion 6. The inner annular portion 7 is formed to become gradually thinner from the outer circumferential edge which is positioned on the upper side to the inner circumferential edge which is positioned on the lower side. The inner diameter of the inner annular portion 7 is set to be larger than the outer diameter of the coating object 200. For example, the inner diameter of the inner annular portion 7 is set to be larger than the outer diameter of the coating object 200 by 1 mm to 2 mm.

The inner circumferential edge of the inner annular potion 7 is formed as an opening 7a. Over the opening 7a, a film 100a of the coating liquid 100 is stretched. The film 100a is stretched when the film forming body 3 is pulled out after being immersed in the coating liquid 100 which is stored in the liquid storing vessel 2. The film 100a can be stretched over the opening 7a because the coating liquid 100 has a certain range of surface tension, namely, small surface tension. Further, since the coating liquid 100 has certain viscosity, the thickness of the film 100a is large so as to hardly blow up.

As described above, the film forming body 3 is formed such that the inner annular portion 7 becomes thinner toward the lower side and thus the thickness of the inner circumferential edge is small. Accordingly, the film 100a can be easily formed on the opening 7a.

The elevating unit 4 includes a pedestal 8 which is placed on a placing surface 300, a column 9 which extends upward from the pedestal 8, a moving body 10 which is supported by the column 9 to be able to move in the vertical direction, a driving mechanism which moves the moving body 10 and is not depicted, and a controller which controls a moving speed, a moving direction, and the like of the moving body 10 and is not depicted, as depicted in FIG. 1.

The moving body 10 is composed of a moving portion 11 which is supported by the column 9, a protrusion portion 12 which is protruded to the right side from the upper end part of the moving portion 11, an arm portion 13 which is protruded downward from the right end part of the protrusion portion 12, and an attachment portion 14 which is provided on the lower end part of the arm portion 13.

On the attachment portion 14, screw insertion holes 14a and 14a are formed.

The film forming body 3 is fixed to the moving body 10 such that the outer annular portion 6 is positioned below the attachment portion 14 of the moving body 10 and screws 15 and 15 which are respectively inserted into the screw insertion holes 14a and 14a formed on the attachment portion 14 are respectively engaged with the fixation screw holes 6a and 6a which are formed on the outer annular portion 6. Accordingly, the film forming body 3 is moved in the vertical direction in association with the movement of the moving body 10.

### [Operation of Coating Apparatus]

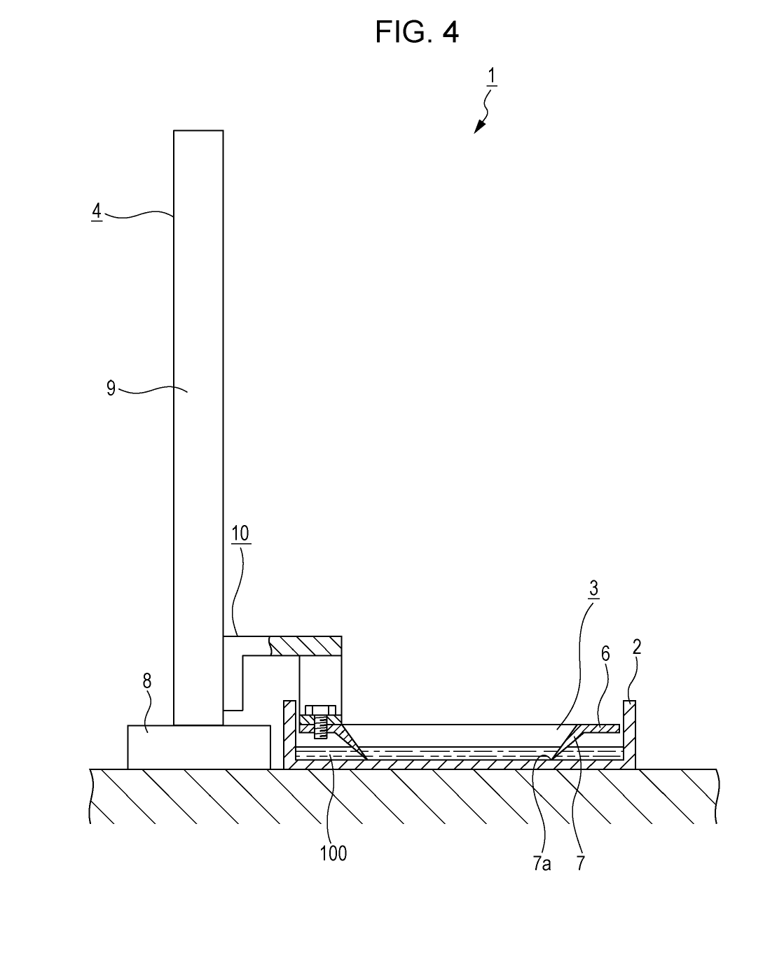

An operation of the coating apparatus 1 is described below (refer to FIGS. 4 to 13).

In an initial state before the coating liquid 100 is applied to the coating object 200, the opening 7a of the film forming body 3 is disposed in a manner to be immersed in the coating liquid 100 in the liquid storing vessel 2 (refer to FIG. 4). At this time, the opening 7a of the film forming body 3 is set to face in the vertical direction and the outer annular portion 6 is positioned on an upper side compared to the inner annular portion 7.

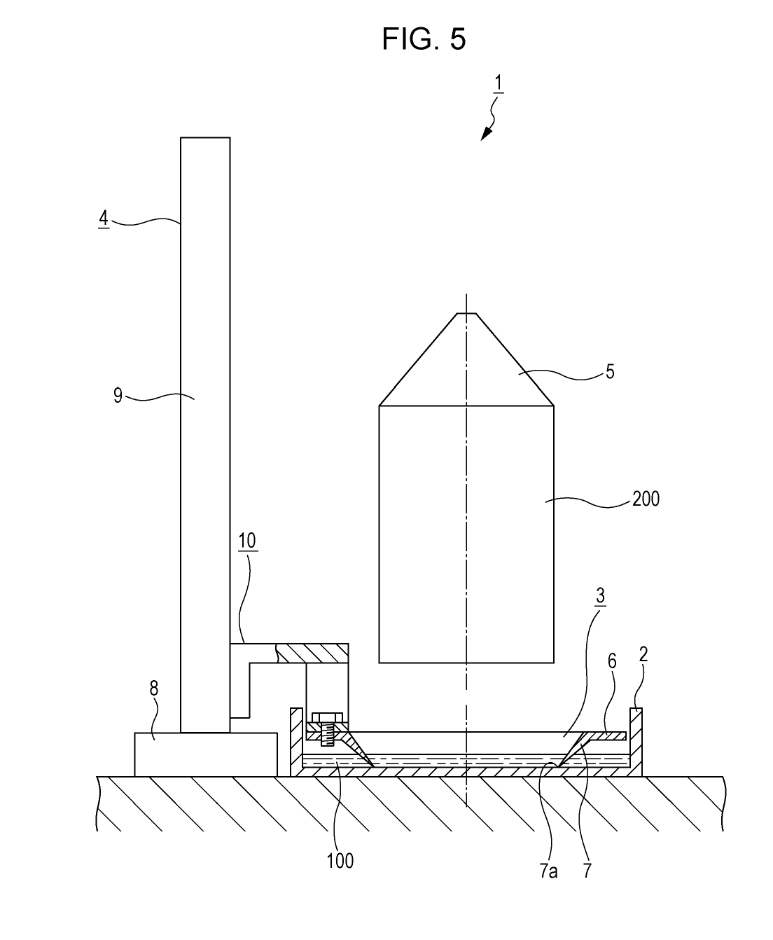

First, the coating object 200 is set to be held by a holding mechanism above the coating liquid 100 which is stored in the liquid storing vessel 2 (refer to FIG. 5). At this time, a central axis of the coating object 200 and a central axis of the opening 7a of the film forming body 3 are accorded with each other.

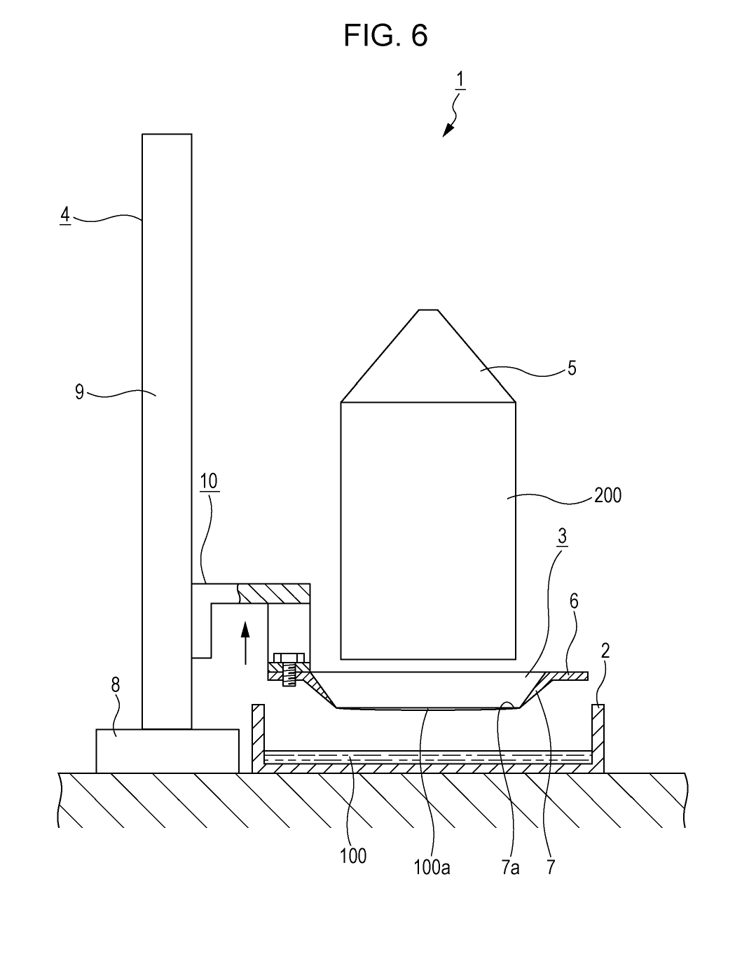

Then, the film forming body 3 which is fixed to the moving body 10 of the elevating unit 4 is moved upward (in an axis direction of the coating object 200) by the elevating unit 4 so as to be positioned above a liquid surface of the coating liquid 100 (refer to FIG. 6).

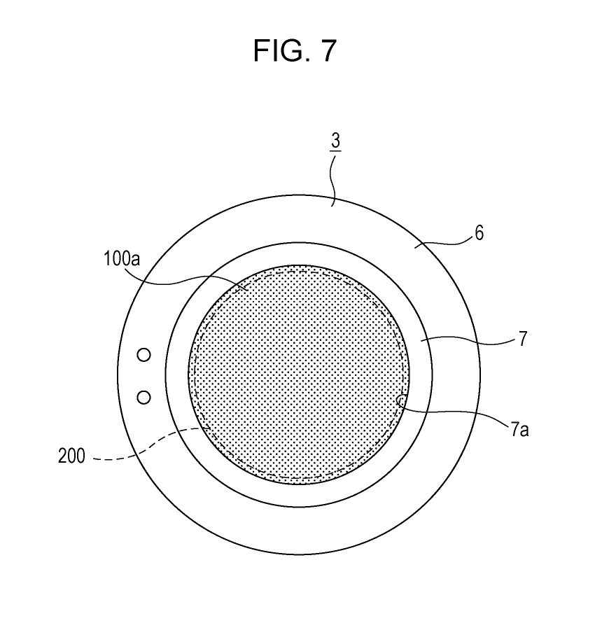

When the opening 7a of the film forming body 3 is moved to be positioned above the liquid surface of the coating liquid 100 by the upward movement of the film forming body 3 from the state that the opening 7a is immersed in the coating liquid 100, the film 100a of the coating liquid 100 is stretched over the opening 7a (refer to FIG. 7).

As described above, the inner circumferential edge (front end edge) of the inner annular portion 7 is positioned lower than the inner circumferential portion 6. Accordingly, even in a case where the film forming body 3 is tilted with respect to the horizontal direction due to own weight or a fixed state with respect to the moving body 10, it is hard for the inner circumferential edge of the outer annular portion 6 to be immersed in the coating liquid 100, being able to securely stretch the film 100a over the opening 7a of the film forming body 3.

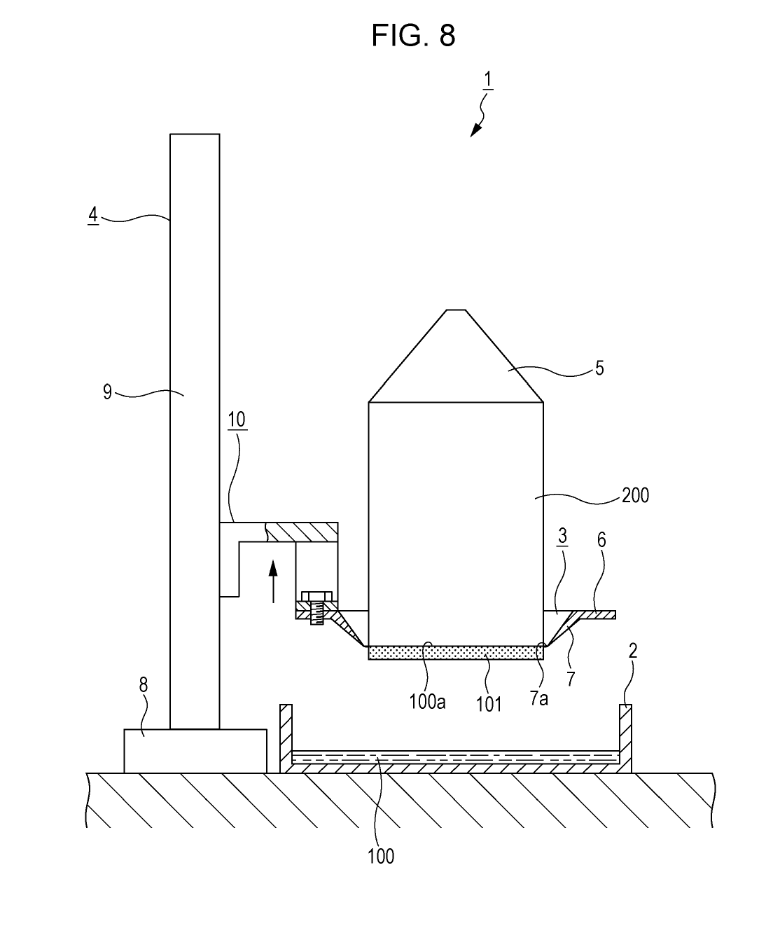

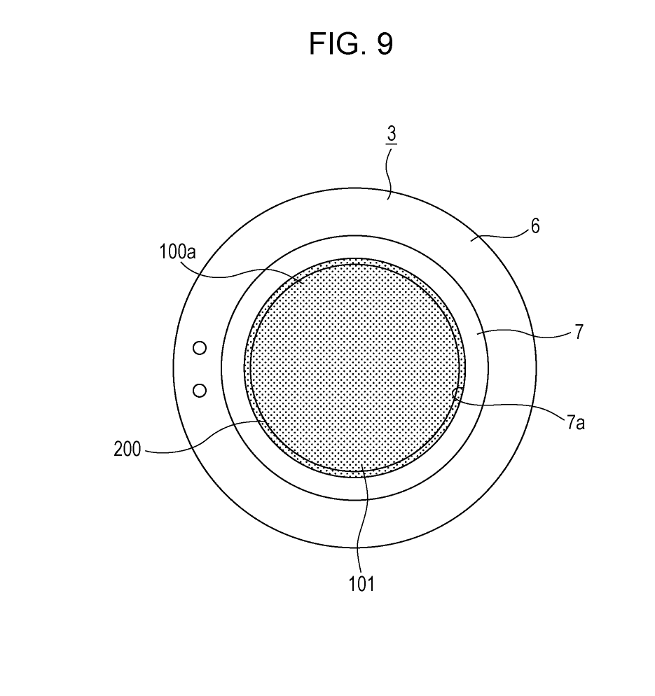

Subsequently, the film forming body 3 is moved upward to be higher than the lower surface of the coating object 200 (refer to FIG. 8). At this time, a certain gap, for example, a gap of 1 mm to 2 mm is formed between the inner circumferential edge of the inner annular portion 7 and the outer surface of the coating object 200.

When the film forming body 3 is moved higher than the lower surface of the coating object 200, part of the film 100a which is stretched over the opening 7a of the film forming body 3 is stuck from the lower surface of the coating object 200 to the lower end portion of the outer circumferential face, forming a coating film 101 (refer to FIG. 9).

Here, when the film forming body 3 is moved higher than the lower surface of the coating object 200 and the film 100a is stuck from the lower surface of the coating object 200 to the lower end portion of the outer circumferential face, the film 100a may tear depending on a shape of the lower end portion of the coating object 200 or strength of the film 100a.

When there is a possibility that the film 100a tears, the lower end portion of the coating object 200 may be immersed in the coating liquid 100 together with the opening 7a of the film forming body 3 and the upward movement of the film forming body 3 may be started in this state.

If the upward movement of the film forming body 3 is started in a state that the lower end portion of the coating object 200 is immersed in the coating liquid 100 together with the opening 7a of the film forming body 3, the film 100a is formed between the outer circumferential face of the coating object 200 and the inner circumferential edge of the film forming body 3 when the film forming body 3 is moved to be higher than the liquid surface of the coating liquid 100.

Accordingly, an area of the film 100a is small, being able to reduce the used amount of the coating liquid 100.

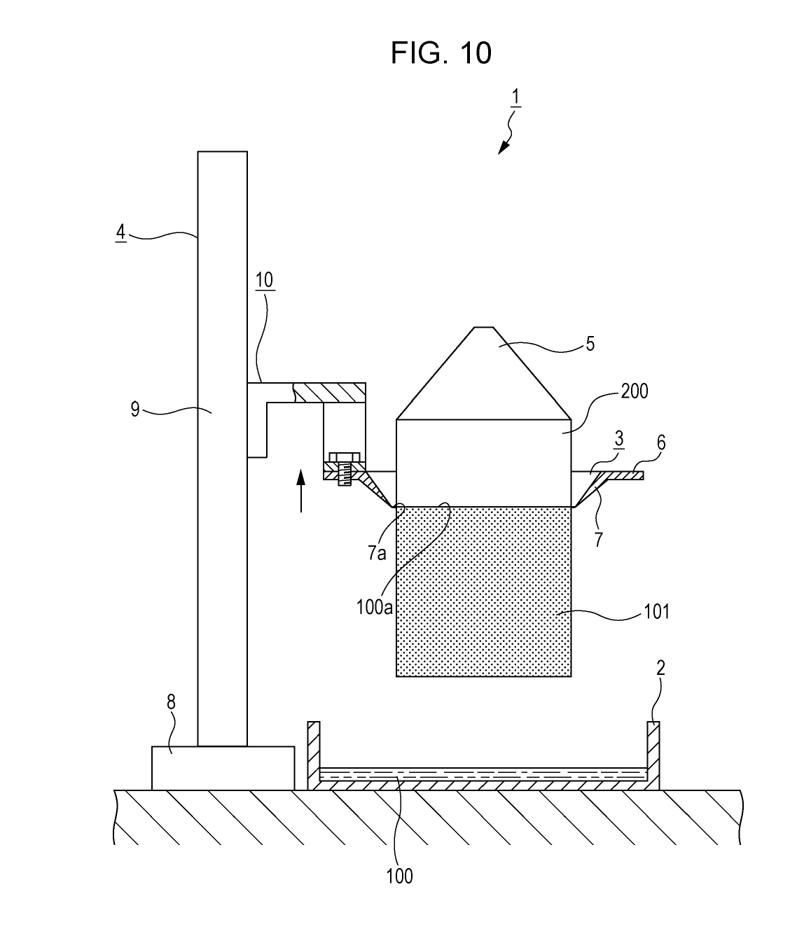

Subsequently, the film forming body 3 is moved upward at low speed, for example, 0.1 mm/s in a manner to be controlled by a controller of the elevating unit 4 (refer to FIG. 10). At this time, the gap between the inner circumferential edge of the inner annular portion 7 and the coating object 200 is set to be constant.

As the film forming body 3 is moved upward, the outer circumferential portion of the film 100a is moved upward along with the movement of the film forming body 3. Therefore, the film 100a is sequentially stuck on the outer circumferential face of the coating object 200 from the lower side to the upper side, forming the coating film 101.

As described above, in the coating apparatus 1, the film forming body 3 is moved upward at low speed by the elevating unit 4, so that excessive external force is not applied on the film 100a which is stretched over the opening 7a of the film forming body 3, being able to prevent a tear of the film 100a.

Further, as described above, the inner annular portion 7 is tilted with respect to the outer annular portion 6 as being closer to the opening 7a from the inner circumferential edge of the outer annular portion 6 and the inner circumferential edge of the inner annular portion 7 is positioned inside the inner circumferential edge of the outer annular portion 6. Accordingly, the inner circumferential edge of the inner annular portion 7 on which the film 100a is formed is positioned closest to the coating object 200, being able to prevent part, on which the film 100a is not formed, other than the inner circumferential edge of the inner annular portion 7 and the outer annular portion 6 from contacting with the coating object 200.

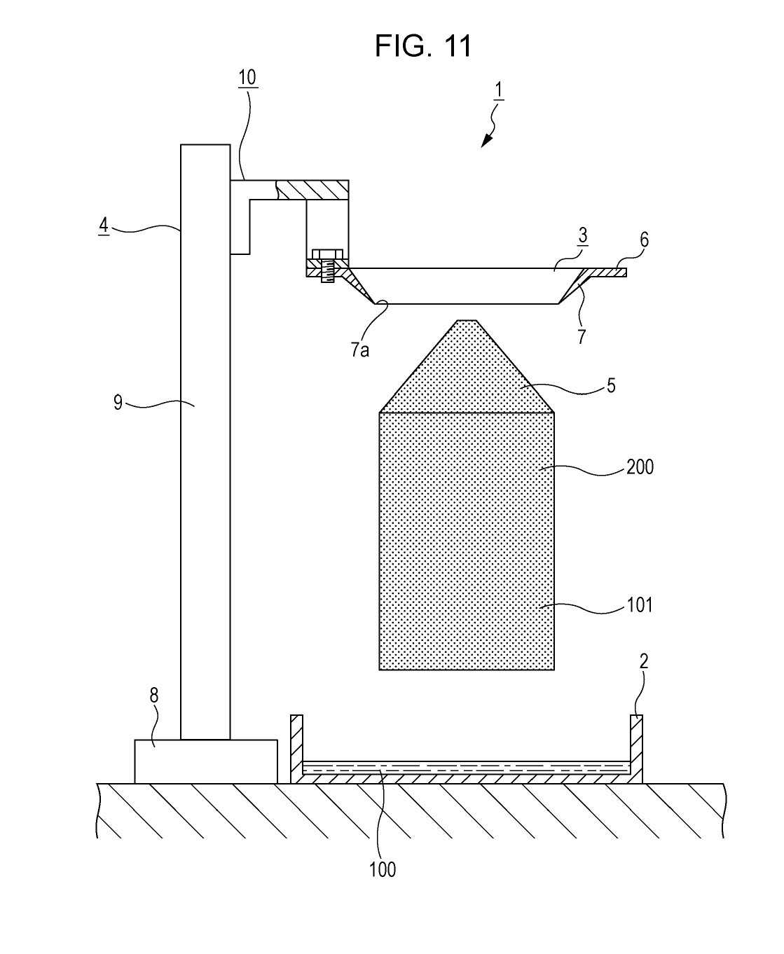

Subsequently, the film forming body 3 is moved upward and the movement is stopped at a position higher than the dripping prevention body 5 which is attached on the upper surface of the coating object 200 (refer to FIG. 11).

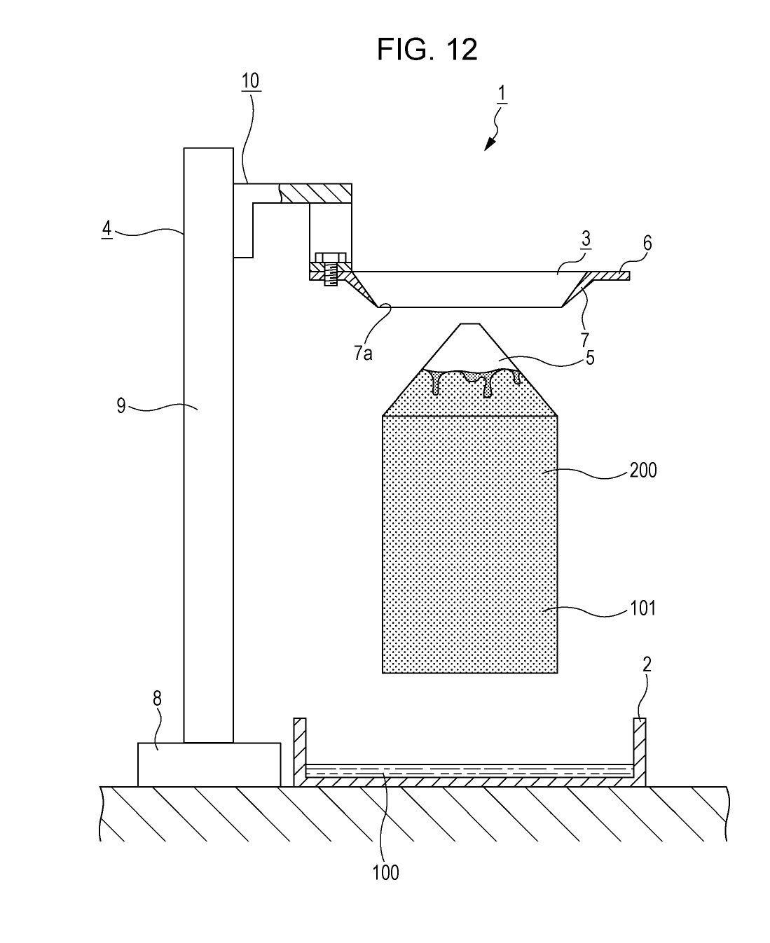

Immediately before the movement of the film forming body 3 is stopped, the coating film 101 is formed in a state that the coating film 100a is stuck on at least part of the dripping prevention body 5. At this time, dripping of the coating liquid 100 occurs on a surface of the dripping prevention body 5 in a case where the film 100a tears, as well (refer to FIG. 12).

Accordingly, dripping of the coating liquid 100 with respect to the outer circumferential face of the coating object 200 can be prevented, being able to secure a favorable forming state of the coating film 101 with respect to the coating object 200.

Here, the example in which the dripping prevention body 5 is attached on the upper surface of the coating object 200 is illustrated above, but other configuration other than the dripping prevention body 5 may be employed as the configuration that prevents dripping of the coating liquid 100 with respect to the outer circumferential face of the coating object 200. For example, instead of the use of the dripping prevention body 5, the upper end portion of the coating object 200 may be formed to be tapered upward.

As described above, the coating film 101 is formed on the whole of the outer circumferential face of the coating object 200 by moving the film forming body 3 to the position higher than the dripping prevention body 5.

In the coating apparatus 1 described above, the movement amount of the film forming body 3 is set to be approximately equal to the length of the coating object 200 in the axis direction (vertical direction). Thus, the movement amount of the film forming body 3 is not excessively larger than the size of the coating object 200, being able to reduce the size of the coating apparatus 1.

Subsequently, processing such as drying is performed with respect to the coating object 200.

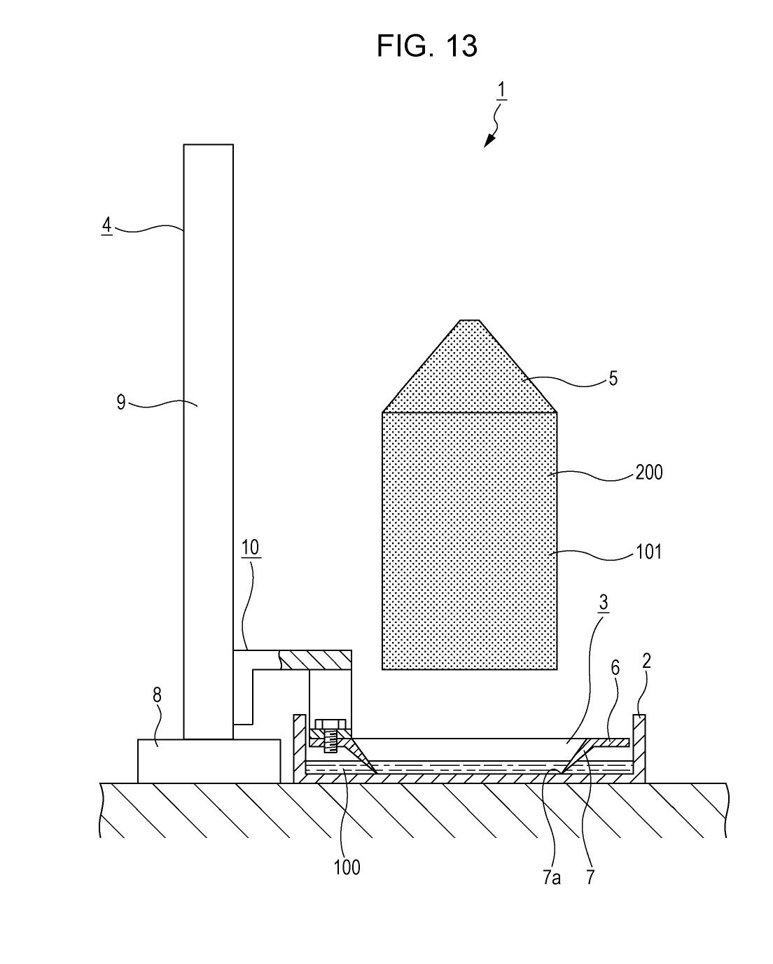

Then, the film forming body 3 is moved downward by the elevating unit 4 so as to be positioned in a state that the opening 7a is immersed in the coating liquid 100 inside the liquid storing vessel 2 (refer to FIG. 13). That is, the film forming body 3 returns to the initial state.

Successively, the above-described operation of the coating apparatus 1 is repeated as necessary. That is, the film forming body 3 is moved back and forth with respect to the coating object 200.

Thus, the coating apparatus 1 repeatedly applies the coating liquid 100 on the coating object 200, being able to adjust the film thickness of the coating film 101 which is formed on the outer circumferential face of the coating object 200.

In the above-described example, the cylindrical or columnar base material is used as the coating object 200. However, the coating object 200 is not limited to the cylindrical or columnar base material, but base materials having various shapes such as a spherical shape and a plate-like shape, for example, silicon wafer or glass wafer may be used.

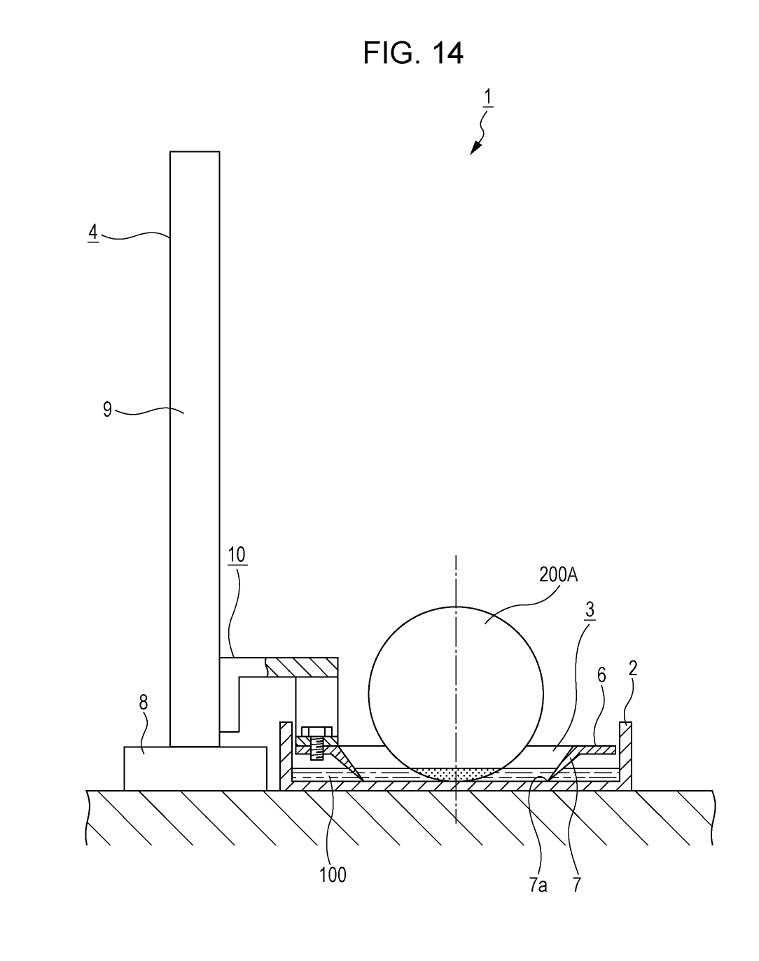

An example of an operation of the coating apparatus 1 in a case where a spherical base material is used as a coating object 200A is described below (refer to FIGS. 14 to 17).

In a state before the coating liquid 100 is applied to the coating object 200A, the opening 7a of the film forming body 3 is disposed in a manner to be immersed in the coating liquid 100 and the coating object 200A is disposed such that a lower end portion thereof is immersed in the coating liquid 100, in the liquid storing vessel 2 (refer to FIG. 14). At this time, a central axis of the coating object 200A in the vertical direction and a central axis of the opening 7a of the film forming body 3 are accorded with each other.

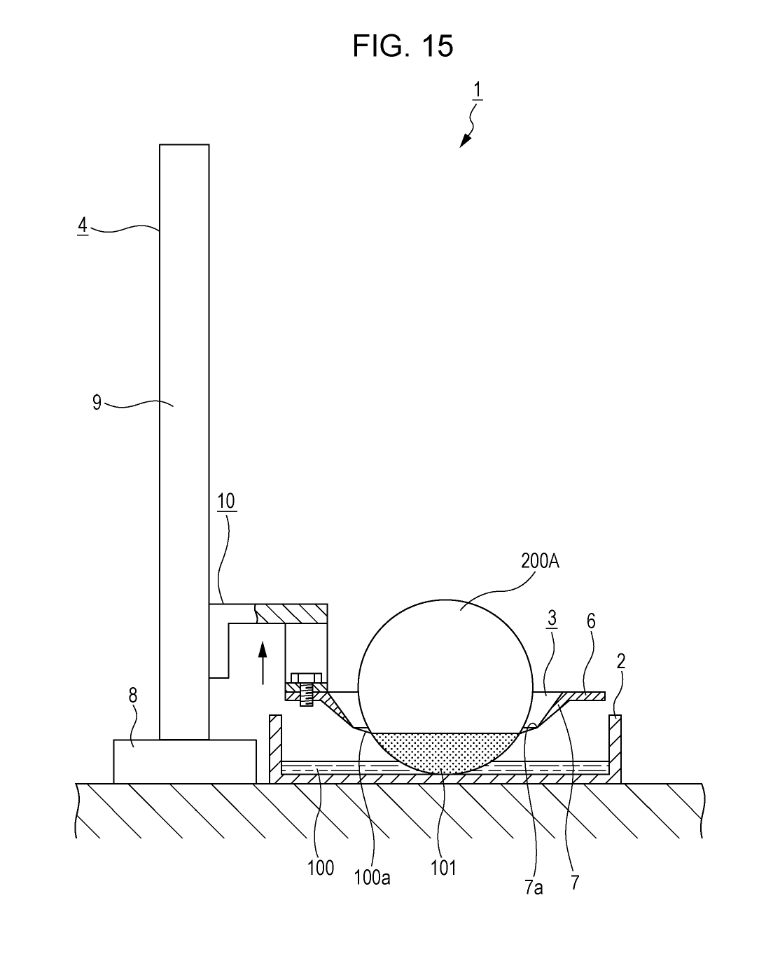

Then, upward movement (in the axis direction of the opening 7a) of the film forming body 3 which is attached to the moving body 10 is started by the elevating unit 4 from the state that both of the opening 7a of the film forming body 3 and the lower end portion of the coating object 200A are immersed in the coating liquid 100 (refer to FIG. 15).

Alternatively, the upward movement of the film forming body 3 may be started in a state that the coating object 200A is positioned above the coating liquid 100.

When the upward movement of the film forming body 3 is started, the film 100a is stretched between the film forming body 3 and the coating object 200A at the opening 7a of the film forming body 3 and part of the film 100a stretched over the opening 7a of the film forming body 3 is stuck to an outer circumferential face of the lower end portion, which is not immersed in the coating liquid 100, of the coating object 200A, forming the coating film 101.

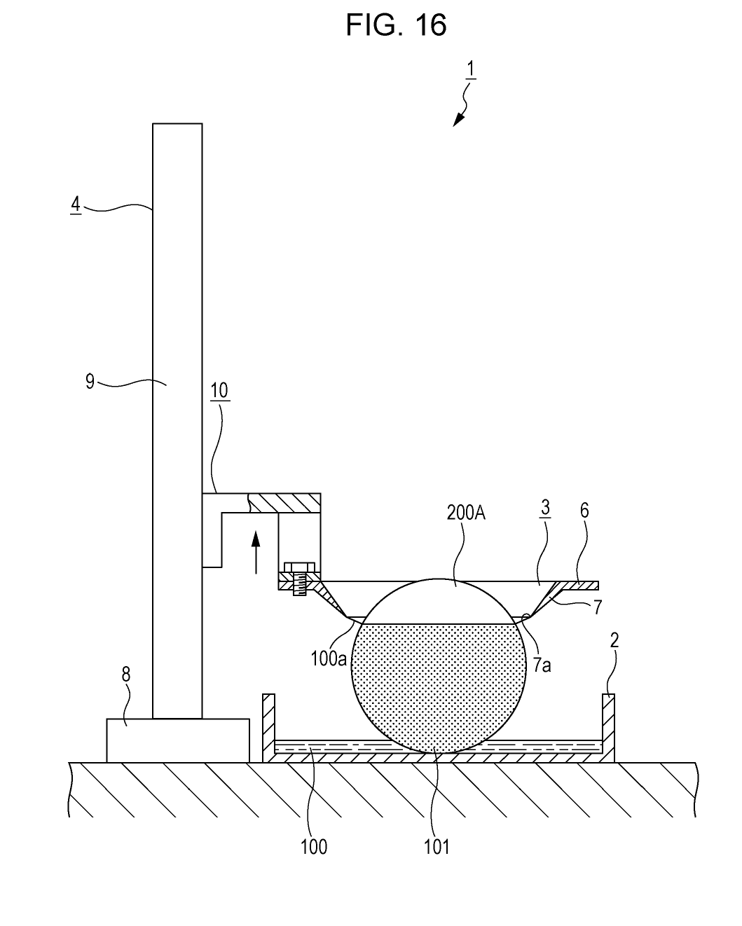

Subsequently, the film forming body 3 is moved upward in a manner that the moving speed is controlled by the controller of the elevating unit 4 (refer to FIG. 16).

As the film forming body 3 is moved upward, the film 100a is sequentially stuck to the outer circumferential face of the coating object 200A from the lower side to the upper side and thus the coating film 101 is formed.

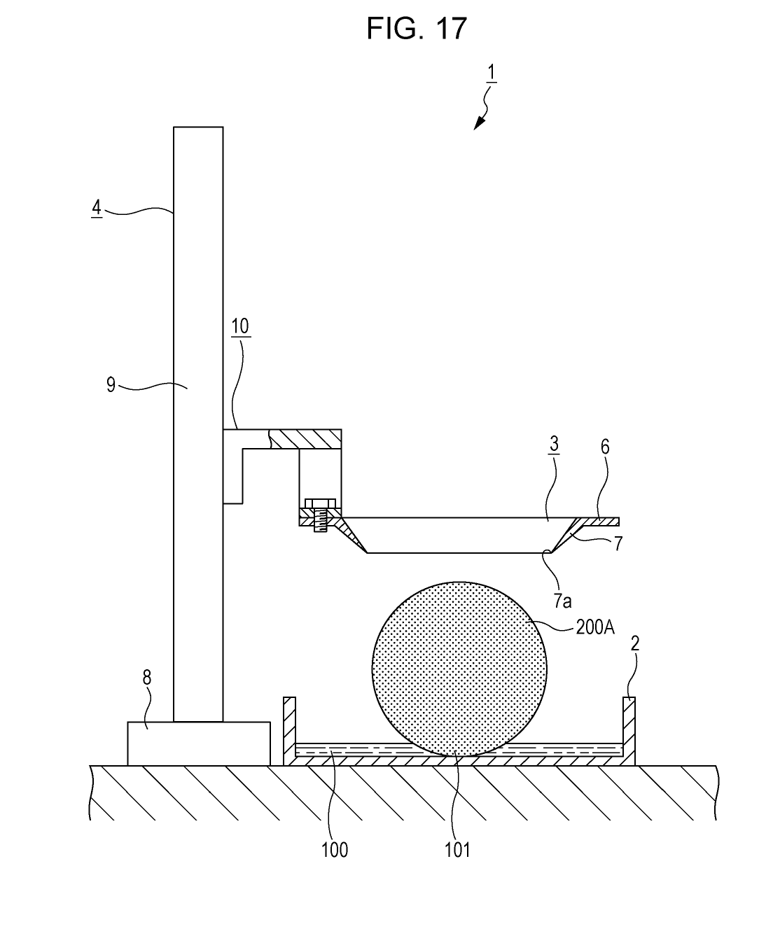

Then, the film forming body 3 is moved upward and the movement is stopped on a position higher than the coating object 200A (refer to FIG. 17).

Thus, the film forming body 3 is moved to the position higher than the coating object 200A, forming the coating film 101 on the whole of the outer circumferential face of the coating object 200A.

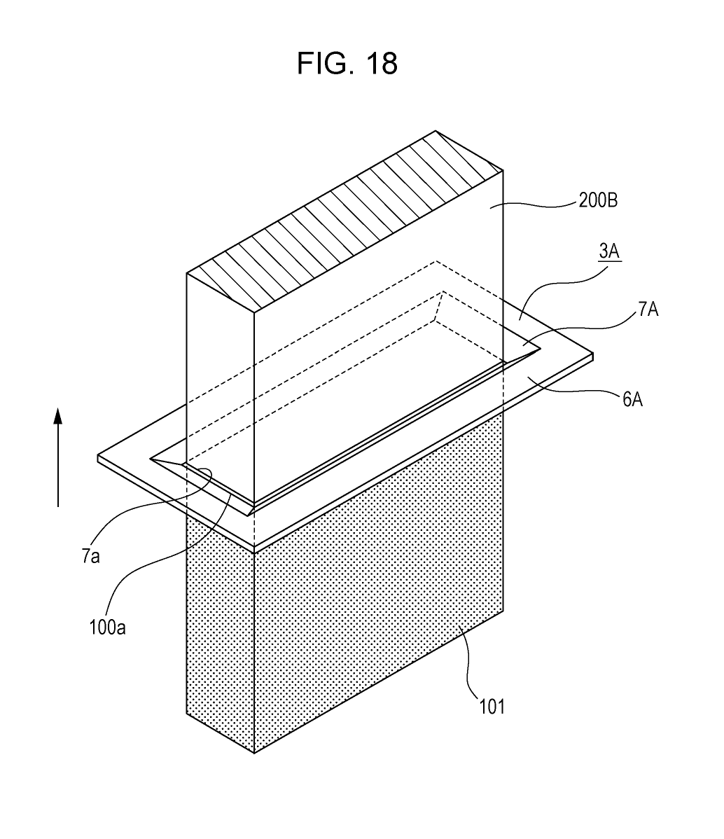

The configuration and the like in a case where a plate-shaped base material is used as a coating object 200B is described below (refer to FIG. 18).

The coating object 200B is disposed in a manner that a longitudinal direction is set to be in a vertical direction, for example.

A film forming body 3A is used for the coating object 200B. An outer annular portion 6A and an inner annular portion 7A of the film forming body 3A are formed in a manner to correspond to the shape of the coating object 200B as described below.

The film forming body 3A is composed of the outer annular portion 6A which is formed to have a plate-like rectangular annular shape facing in the vertical direction and the inner annular portion 7A which is protruded from the whole of the inner circumferential edge of the outer annular portion 6A.

The inner annular portion 7A is tilted such that the inner annular portion 7A is displaced inward from the inner circumferential edge of the outer annular portion 6A toward the lower side. The front end edge (inner circumferential edge) of the inner annular portion 7A is formed rectangular.

The inner circumferential edge of the inner annular portion 7A is formed as the opening 7a. The opening 7a is formed slightly larger than the horizontal sectional shape of the coating object 200B. That is, the coating object 200B can be inserted into the opening 7a of the inner annular portion 7A.

In a state before the coating liquid 100 is applied to the coating object 200B, the opening 7a of the film forming body 3A is immersed in the coating liquid 100 and the coating object 200B is disposed on a position on which the coating object 200B can be inserted into the opening 7a. Then, upward movement of the film forming body 3A (in the axis direction of the opening 7a) is started, and thus the film forming body 3A is moved upward in a state that the coating object 200B is inserted into the opening 7a. Subsequently, the film forming body 3A is moved upward and the movement is stopped on a position higher than the upper end portion of the coating object 200B.

Thus, the coating film 101 is formed on the whole of the outer circumferential face of the coating object 200B which has a plate-like shape, by moving the film forming body 3A from the lower end side of the coating object 200B to the upper end side.

### [Modification of Coating Apparatus]

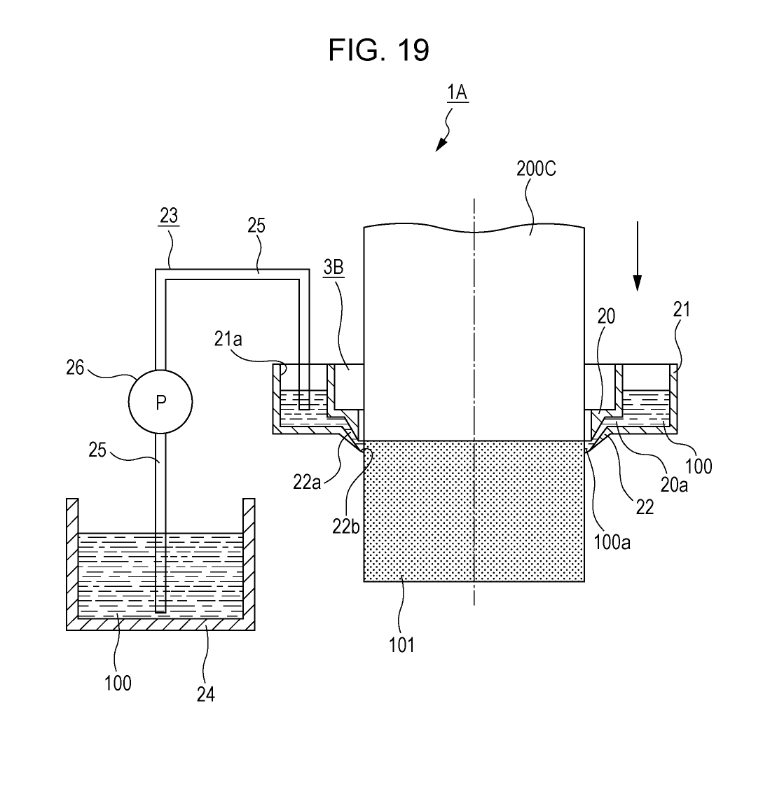

A modification of the coating apparatus is described below (refer to FIG. 19).

In a coating apparatus according to the modification described below, only the configuration of a film forming body and part of other configuration are different from those of the coating apparatus 1 described above. Therefore, only part different from the coating apparatus 1 is described in detail, and other parts are given the same reference characters as those of the coating apparatus 1 and the description thereof is skipped.

### [Configuration of Coating Apparatus According to Modification]

As a coating object 200C on which the coating film 101 is formed by a coating apparatus 1A according to the modification, a cylindrical base material having long length in an axis direction is used, for example.

As depicted in FIG. 19, a film forming body 3B includes a base face portion 20 which is formed in an annular shape and of which the axis direction is in the vertical direction, a liquid storing portion 21 which is protruded upward from a part other than an inner circumferential portion of the base face portion 20, and a delivery portion 22 which is protruded downward from the inner circumferential portion of the base face portion 20.

In the base face portion 20, an inner circumferential edge is formed in a round shape and an inner diameter is larger than an outer diameter of the coating object 200C. The base face portion 20 includes a flow path 20a thereinside.

In the liquid storing portion 21, a concave portion which is opened upward is formed as a liquid storing space 21a. The liquid storing space 21a communicates with the flow path 20a of the base face portion 20.

The delivery portion 22 includes a liquid delivery path 22a thereinside. The liquid delivery path 22a is tilted so as to be displaced inward toward the lower side. The upper end of the liquid delivery path 22a communicates with the flow path 20a and the lower end communicates with a space formed inside the delivery portion 22. A lower edge of the delivery portion 22 is formed as an opening 22b over which the film 100a of the coating liquid 100 is stretched. Accordingly, the liquid delivery path 22a is tilted so as to be displaced downward as being closer to the opening 22b.

The liquid storing space 21a, the flow path 20a, and the liquid delivery path 22a sequentially communicates with each other inside the film forming body 3B. The liquid storing space 21a has a larger volume than those of the flow path 20a and the liquid delivery path 22a. The flow path 20a and the liquid delivery path 22a are formed to be narrow spaces.

The coating liquid 100 is supplied to the liquid storing space 21a of the liquid storing portion 21 by a later-described liquid supply mechanism, and the coating liquid 100 which is supplied is allowed to flow via the flow path 20a to the liquid delivery path 22a and is delivered from the liquid delivery path 22a so as to form the film 100a.

As described above, the liquid delivery path 22a of the delivery portion 22 is tilted so as to be displaced downward as being closer to the opening 22b, so that the coating liquid 100 is easily allowed to flow toward the opening 22b by gravity, being able to easily deliver the coating liquid 100 to the film 100a which is stretched over the opening 22a.

Further, the liquid delivery path 22a of the delivery portion 22 is formed to be the narrow spaces compared to the liquid storing space 21a as described above. Accordingly, the coating liquid 100 is easily allowed to flow from the delivery portion 22 toward the opening 22b by capillary action, thereby being able to be securely delivered to the film 100a which is stretched over the opening 22b. Further, the configuration such as a pump for delivering the coating liquid 100 to the opening 22b does not have to be provided, being able to simplify the configuration.

To the coating apparatus 1A, a liquid supply mechanism 23 for supplying the coating liquid 100 to the liquid storing portion 21 is provided. The liquid supply mechanism 23 includes a storing tank 24 which stores the coating liquid 100, a delivery tube 25 which functions as a flow path of the coating liquid 100 from the storing tank 24 to the liquid storing portion 21, and a pump 26 which delivers the coating liquid 100 from the storing tank 24 to the liquid storing portion 21.

### [Operation of Coating Apparatus According to Modification]

In the coating apparatus 1A described above, the film forming body 3B is fixed on a predetermined position in a state that the film 100a is stretched over the opening 22b and the coating object 200C is inserted into the opening 22b of the film forming body 3B and moved downward in a state that the central axis of the coating object 200C and the central axis of the opening 22b are accorded with each other. At this time, the coating liquid 100 is supplied from the liquid supply mechanism 23 to the liquid storing portion 21 and the coating liquid 100 stored in the liquid storing portion 21 is sequentially supplied to the opening 22b by the delivery portion 22.

Accordingly, the film 100a stretched over the opening 22b of the film forming body 3B is prevented from tearing due to liquid discontinuity and therefore the coating liquid 100 can be continuously applied to the coating object 200C, being able to form the coating film 101 on the coating object 200C which expands long in the axis direction.

In the above-described example, the coating liquid 100 is delivered from the delivery portion 22 to the opening 22b by capillary action or gravity. However, the coating liquid 100 is not delivered from the delivery portion 22 to the opening 22b limitedly by the capillary action or gravity. For example, the coating liquid 100 stored in the liquid storing portion 21 may be delivered to the opening 22b by pressure generated by using a pump or the like.

Further, in the above-described example, the liquid supply mechanism 23 includes the storing tank 24, the delivery tube 25, and the pump 26. However, the liquid supply mechanism is not limited to the example including the storing tank 24, the delivery tube 25, and the pump 26. It is sufficient for the liquid supply mechanism to have a function to supply the coating liquid 100 to the liquid storing portion 21. For example, the coating liquid 100 may be delivered by gravity without providing the pump 26.

Furthermore, in the above-described example, the cylindrical base material which expands long in the axis direction is used as the coating object 200C. However, the coating object is not limited to the long cylindrical base material, but a base material having various shapes such as a long-plate shape may be used as the coating object 200C.

### [Overview]

As described above, in the coating apparatuses 1 and 1A, the film forming bodies 3, 3A, and 3B having the openings 7a and 22b are moved relatively to the coating objects 200, 200A, 200B, and 200C and the coating objects 200, 200A, 200B, and 200C are inserted into the openings 7a and 22b over which the film 100a of the coating liquid 100 is stretched so as to apply the coating liquid 100 on the surfaces of the coating objects 200, 200A, 200B, and 200C.

Accordingly, the coating film 101 is formed on the surfaces of the coating objects 200, 200A, 200B, and 200C by the film 100a of the coating liquid 100 which is stretched over the openings 7a and 22b, so that the used amount of the coating liquid 100 is small. Thus, the used amount of the coating liquid 100 can be reduced.

Further, in the coating apparatuses 1 and 1A, the coating film 101 is formed on the surfaces of the coating objects 200, 200A, 200B, and 200C by the film 100a which is stretched over the openings 7a and 22b of the film forming bodies 3, 3A, and 3B, so that the coating liquid 100 does not leak from the film forming bodies 3, 3A, and 3B. Accordingly, a mechanism for preventing leak does not have to be provided to the coating apparatuses 1 and 1A, being able to simplify the configuration of the coating apparatuses 1 and 1A.

### [Present Application]

The present application may have the following configuration.

(1) A coating apparatus includes a liquid storing vessel in which coating liquid to be applied to a coating object is stored, and a film forming body that has an annular shape and includes an opening over which a film is stretched by immersing the film forming body in the coating liquid that is stored in the liquid storing vessel. In the coating apparatus, the film forming body is moved relatively to the coating object and the coating object is inserted into the opening over which the film is stretched, so as to apply the coating liquid on a surface of the coating object.

(2) In the coating apparatus according to (1), the film forming body includes an outer annular portion that is formed in an annular shape and an inner annular portion that is formed in an annular shape, includes the opening, and is protruded from an inner circumferential edge of the outer annular portion, and a front end edge of the inner annular portion is positioned lower than the inner circumferential edge of the outer annular portion.

(3) In the coating apparatus according to (2), the inner annular portion is tilted with respect to the outer annular portion as being closer to the opening from the inner circumferential edge of the outer annular portion, and an inner circumferential edge of the inner annular portion is positioned inside the inner circumferential edge of the outer annular portion.

(4) In the coating apparatus according to any one of (1) to (3), movement of the film forming body is started in a state that a lower end portion of the coating object and at least the opening of the film forming body are immersed in the coating liquid that is stored in the liquid storing vessel.

(5) In the coating apparatus according to any one of (1) to (4), a dripping prevention body that is formed to have a shape tapered in a direction in which the film forming body is moved is attached on an end portion, which is positioned in the direction in which the film forming body is moved, of the coating object.

(6) In the coating apparatus according to any one of (1) to (5), the film forming body is moved back and forth with respect to the coating object.

(7) The coating apparatus according to (1) further includes a liquid supply mechanism configured to supply the coating liquid to a liquid storing portion, and in the coating apparatus, the film forming body includes the liquid storing portion that stores the coating liquid and a delivery portion that delivers the coating liquid that is stored in the liquid storing portion to the opening.

(8) In the coating apparatus according to (7), the delivery portion is tilted so as to be displaced downward as being closer to the opening.

(9) In the coating apparatus according to (7) or (8), the coating liquid that is stored in the liquid storing portion is delivered from the delivery portion to the opening by capillary action.

It should be noted that the specific shapes and configurations of respective elements illustrated in the above-described embodiment are merely an example of embodiments of the present application and the technical scope of the present application should not be limitedly interpreted by the example.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A coating apparatus, comprising:
a liquid storing vessel in which coating liquid to be applied to a coating object is stored; and
a film forming body that has an annular shape and includes an opening over which a film is stretched by immersing the film forming body in the coating liquid that is stored in the liquid storing vessel; wherein
the film forming body is moved relatively to the coating object and the coating object is inserted into the opening over which the film is stretched, so as to apply the coating liquid on a surface of the coating object.

2. The coating apparatus according to claim 1, wherein
the film forming body includes an outer annular portion that is formed in an annular shape and an inner annular portion that is formed in an annular shape, includes the opening, and is protruded from an inner circumferential edge of the outer annular portion, and
a front end edge of the inner annular portion is positioned lower than the inner circumferential edge of the outer annular portion.

3. The coating apparatus according to claim 2, wherein
the inner annular portion is tilted with respect to the outer annular portion as being closer to the opening from the inner circumferential edge of the outer annular portion, and
an inner circumferential edge of the inner annular portion is positioned inside the inner circumferential edge of the outer annular portion.

4. The coating apparatus according to claim 1, wherein movement of the film forming body is started in a state that a lower end portion of the coating object and at least the opening of the film forming body are immersed in the coating liquid that is stored in the liquid storing vessel.

5. The coating apparatus according to claim 1, wherein a dripping prevention body, the dripping prevention body being formed to have a shape tapered in a direction in which the film forming body is moved, is attached on an end portion, the end portion being positioned in the direction in which the film forming body is moved, of the coating object.

6. The coating apparatus according to claim 1, wherein the film forming body is moved back and forth with respect to the coating object.

7. The coating apparatus according to claim 1, further comprising:
a liquid supply mechanism configured to supply the coating liquid to a liquid storing portion; wherein
the film forming body includes the liquid storing portion that stores the coating liquid and a delivery portion that delivers the coating liquid that is stored in the liquid storing portion to the opening.

8. The coating apparatus according to claim 7, wherein the delivery portion is tilted so as to be displaced downward as being closer the opening.

9. The coating apparatus according to claim 7, wherein the coating liquid that is stored in the liquid storing portion is delivered from the delivery portion to the opening by capillary action.
